(19) United States
(12) Patent Application Publication
(10) Pub. No.: US 2026/0015862 A1
(43) Pub. Date: Jan. 15, 2026

(54) COLD-FORMED STEEL SPACE TRUSS

(71) Applicant: UNIVERSITY OF NORTH TEXAS, Denton, TX (US)

(72) Inventors: Cheng Yu, Denton, TX (US); Cleirton Andre Silva De Freitas, Denton, TX (US)

(21) Appl. No.: 19/263,708

(22) Filed: Jul. 9, 2025

Related U.S. Application Data
(60) Provisional application No. 63/669,157, filed on Jul. 9, 2024.

(51) Int. Cl. E04C 3/07; B64G 99/00; E04C 3/04

(52) U.S. Cl. CPC E04C 3/07; B64G 99/00; E04C 2003/0417; E04C 2003/0473

(57) ABSTRACT

A space structure assembly of the present disclosure comprises a bottom chord formed member of cold-formed steel; a top chord formed member of cold-formed steel; and at least one diagonal truss member formed of cold-formed steel and having at least two stamped ends, wherein one end of the stamped ends of the at least one diagonal truss member is connected to the bottom chord and a portion of the at least one diagonal truss member is connected to the top chord.

### CROSS-REFERENCE TO RELATED APPLICATION

This application claims priority to co-pending U.S. provisional application entitled, “Cold-Formed Steel Space Truss,” having application No. 63/669,157, filed Jul. 9, 2024, which is entirely incorporated herein by reference.

### BACKGROUND

Space trusses are usually applied in roofs, bridges, industrial buildings, railway platforms, barrel vault structures, dome structures, and floor structures. Space trusses are three-dimensional trusses of steel structures made with bars, generally using pipes or tubes, connected by bolts at the nodes. There are several types of node connections to attach these members, but most of them are expensive or not readily available. On the other hand, cold-formed steel is cheap and the cold rolled steel market size was valued at $1,904,950.26 million (USD) in 2022 and is expected to expand at a CAGR (Compound Annual Growth Rate) of 2.57% during the forecast period, reaching $2,217,610.83 million by 2031.

As an example, composite floors are mainly composed of steel joists, panels, blocking, and connectors as the vertical load-bearing system and horizontal support system for CFS structures. Truss beams are widely used as the main joists of composite floors in assembled floor systems because of their advantages of lower span limitation, easy pipeline arrangement, and effective increase of room net height. Bolted connections are widely used in cold-formed steel (CFS) construction. The shape of the component members and how they are connected determines the paths that loads take through a truss. Concentric, or symmetrical, trusses allow for the load path to be transmitted through the center of gravity of the member. Eccentric, or asymmetrical, allows for the load path to be transmitted away from the center of gravity. The efficiency of a CFS truss is greatly dependent on the shapes of component members and how they are connected. Some asymmetrical trusses could result: Eccentric load path, less lateral stability and less efficient truss.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows truss elements of a typical space structure.

FIGS. 2A and 2B show a perspective view and a top view, respectively, of a novel connection of a cold-formed space structure in accordance with various embodiments of the present disclosure.

FIG. 3 shows disassembled parts of the space structure of FIG. 2A with cold-formed truss members in accordance with the present disclosure.

FIG. 4 is a photographic image of space trusses formed from cold-formed bars of FIG. 3 utilizing an exemplary and novel stamped connection in accordance with various embodiments of the present disclosure.

FIGS. 5A-5C show an exemplary assembly methodology for multidimensional trusses using cold-formed truss members in accordance with various embodiments of the present disclosure.

FIG. 6 depicts centroid axes of a bottom chord and a transverse chord in accordance with the process of FIGS. 5A-5C.

FIG. 7 depicts a connection of one stamped end of a diagonal truss bar above another diagonal truss bar in accordance with the process of FIGS. 5A-5C.

FIGS. 8 and 9 show horizontal and vertical distances between node connections in accordance with the process of FIGS. 5A-5C.

FIGS. 10A-10B shows a truss design geometry for a space structure composed of pyramidal units in accordance with various embodiments of the present disclosure.

FIG. 11A shows dimensions of an exemplary truss member in accordance with various embodiments of the present disclosure.

FIG. 11B provides a table showing geometric properties and moment of inertia of the truss member of FIG. 11A.

FIG. 12 shows a typical pipe finite element model of a truss in accordance with the present disclosure.

FIG. 13 shows an exemplary finite element model of a cold-formed truss using frame elements in accordance with various embodiments of the present disclosure.

FIGS. 14 and 15 show, respectively, the vertical displacement results of a typical pipe node truss and an exemplary cold-formed truss in accordance with various embodiments of the present disclosure.

FIGS. 16 and 17 show a finite element model of a cold-formed truss using shell elements in accordance with various embodiments of the present disclosure.

FIG. 18 shows vertical displacement results of the cold-formed truss model of FIG. 16 in accordance with various embodiments of the present disclosure.

FIG. 19 shows a geometry of an exemplary truss design in accordance with various embodiments of the present disclosure.

FIGS. 20-22 are images of an exemplary manufacturing process for members of a cold-formed truss assembly in accordance with various embodiments of the present disclosure.

FIG. 23 are images depicting the arrangement of bottom chords within the assembly of a cold-formed space structure in accordance with various embodiments of the present disclosure.

FIG. 24 are images depicting the formation of pyramidal units within the assembly of a cold-formed space structure in accordance with various embodiments of the present disclosure.

FIG. 25 are images depicting the arrangement of top chords within the assembly of a cold-formed space structure in accordance with various embodiments of the present disclosure.

FIG. 26 shows positive eccentricities that can be created in truss joints having concentric axes in accordance with various embodiments of the present disclosure.

FIG. 27 is an image depicting a cold-formed 2D connection in accordance with various embodiments of the present disclosure.

FIG. 28 shows concentric axes between diagonal and top chord members of an exemplary cold-formed space structure in accordance with various embodiments of the present disclosure.

FIG. 29 shows a node connection between diagonal bars and a top chord in accordance with various embodiments of the present disclosure.

FIGS. 30-31 shows steps of a fabrication process for an exemplary diagonal bar having a plurality of stamped flanges and peaks in accordance with various embodiments of the present disclosure.

FIG. 32 depicts an assembly process of a 2D truss in accordance with various embodiments of the present disclosure.

FIGS. 33-35 are images depicting a manufacturing and assembly process of a 2D space structure truss truss in accordance with various embodiments of the present disclosure.

FIGS. 36(A)-36(F) shows a general geometry used in testing the assembled 2D space structure truss of FIG. 35 versus conventional 2D space structure truss assemblies.

FIGS. 37(A)-37(F) are individual charts showing load versus displacement results for each of the test structures represented in FIGS. 36(A)-36(F).

FIG. 38 is a single chart load versus displacement results for all of the test structures represented in FIGS. 36(A)-36(F).

### DETAILED DESCRIPTION

The present disclosure presents a new technology for designing, manufacturing and assembling of cold-formed steel space structures based on creating a connection where the axes of cold-formed steel bars are concentric (at the same point), increasing the overall stability of the truss. In accordance with the present disclosure, a new and improved node connection within space structures is developed by stamping a diagonal flange of space structure members.

Also known as three-dimensional trusses, space structures are 2D or 3D steel structures made with bars, generally using pipes or tubes, connected by bolts at the nodes. Although there are several possible types of connections available to attach these members, most of them are expensive or not readily available. Accordingly, systems and methods of the present disclosure utilize cold-formed steel truss members to assemble space structures whose nodes are produced by stamping the ends or flange portions of bars, thus generating a low cost and novel type of node connection.

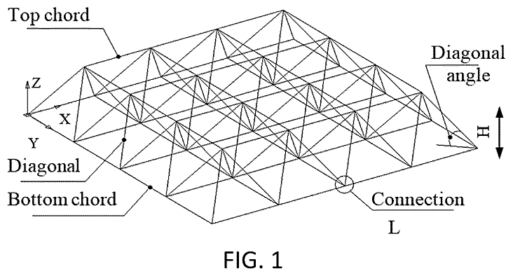

Referring to FIG. 1 (which is credited to Freitas, 2008), space trusses are frequently used at the construction of roofs and are normally made of pipe bars linked by bolts on the connection. Cold-framed steel (CFS) is also called light gauge steel that is mostly made from steel plates, sheets, and strips materials. Cold-framed steel has various advantages such as being easy to fabricate, transport, and install. For example, cold-formed steel is lighter in weight, high strength, and stiffness result in more design options, wider span, and better material usage.

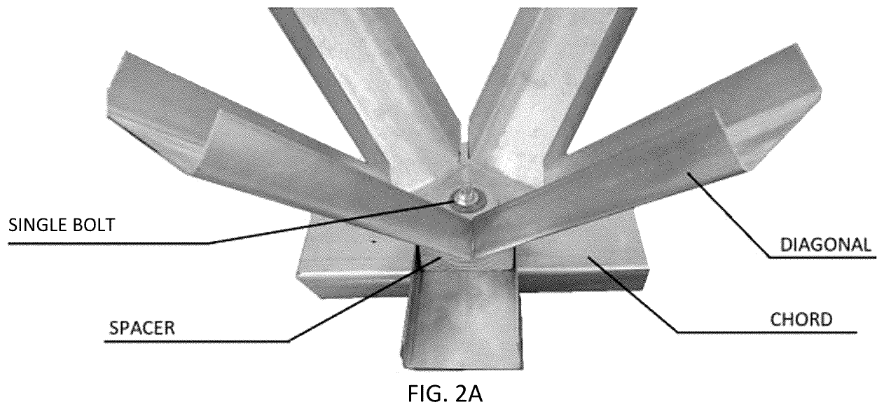

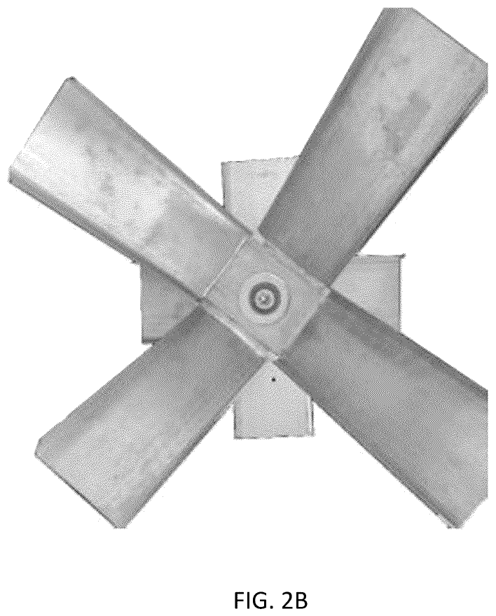

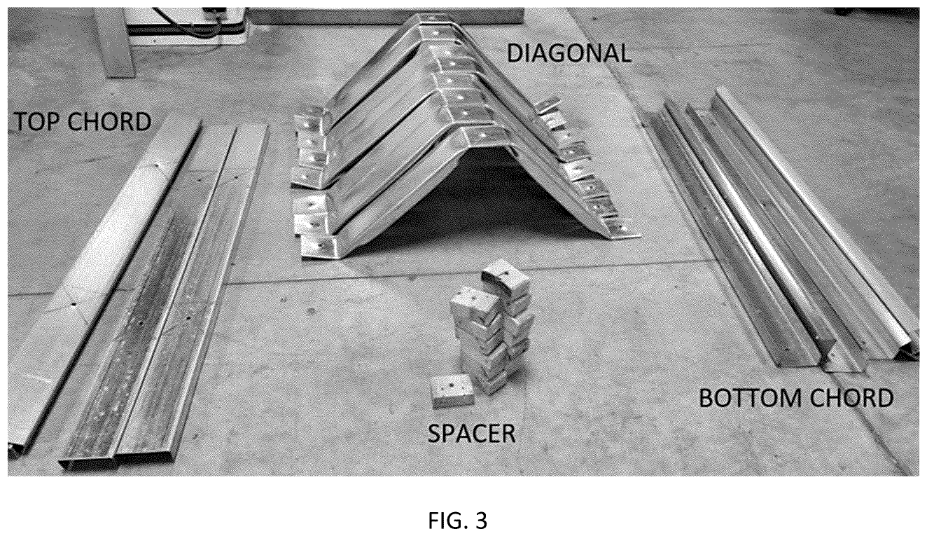

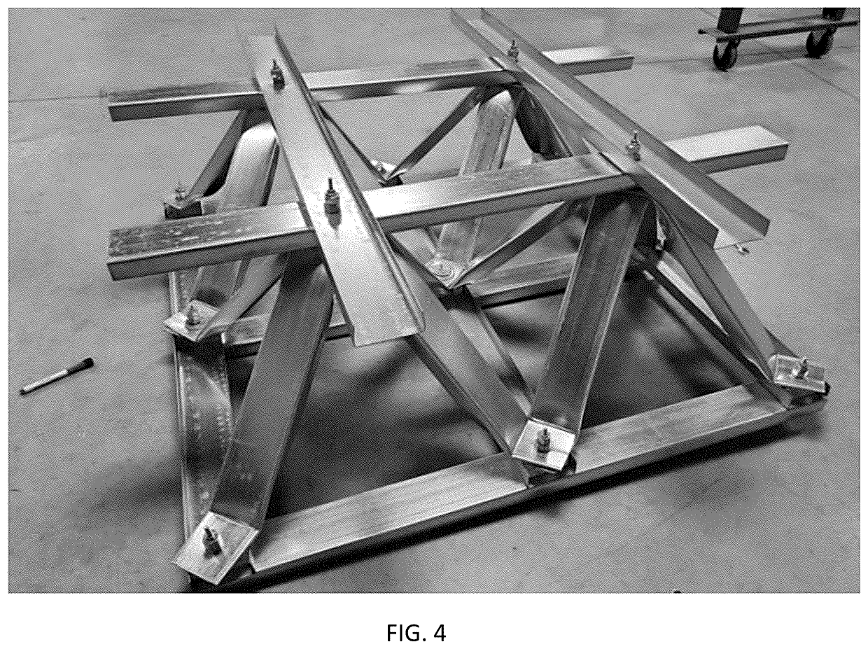

In accordance with the present disclosure, the novel connection of a cold-formed space structure is illustrated in FIGS. 2A-2B, where FIG. 2A shows a perspective view and FIG. 2B shows a top view of a 3D space structure. Correspondingly, FIG. 3 shows disassembled parts of the space truss of FIG. 2A, with cold-formed bars. It is noted that that the top and bottom chords do not necessarily need to have a stamp end, just a hole for a screw connection. In this implementation, a spacer component was made from wood, but could contain other materials. During manufacture, in one embodiment, diagonals members were stamped in pairs. FIG. 4 is a photographic image of space trusses formed from cold-formed bars of FIG. 3 utilizing the exemplary and novel stamped connection (as previously shown in FIGS. 1A-1B).

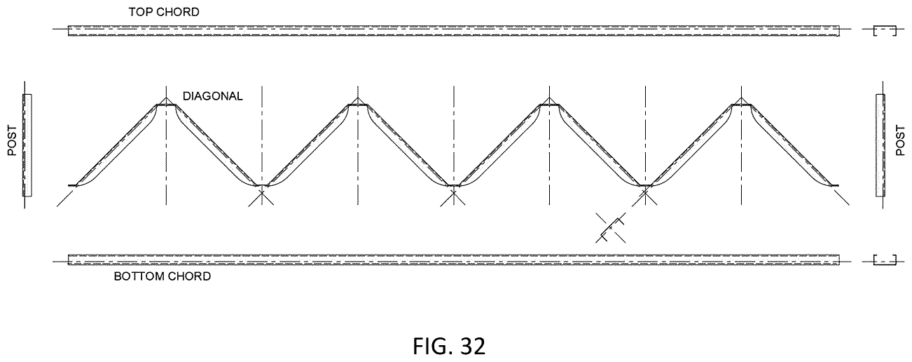

In various embodiments, a diagonal member may be bent in the middle and stamped to form a single peak (e.g., a triangle shape), as shown in FIG. 3. Alternatively, the diagonal member may not be bent or stamped in the middle and may be joined with another diagonal member to form the peak (e.g., a triangle shape). Additionally, in some embodiments, a peak may be formed by multiple portions of the same diagonal member being bent to form the peak, as shown in FIG. 32. Accordingly, diagonal members may be manufactured having alternating peaks between the two stamped ends, such as that shown in FIG. 32, where the peak portion comprises a stamped flange that can be connected to top or bottom chords. In either case, the stamped portions of the diagonal member can be connected to chord or other diagonal pieces with a bolt fastener.

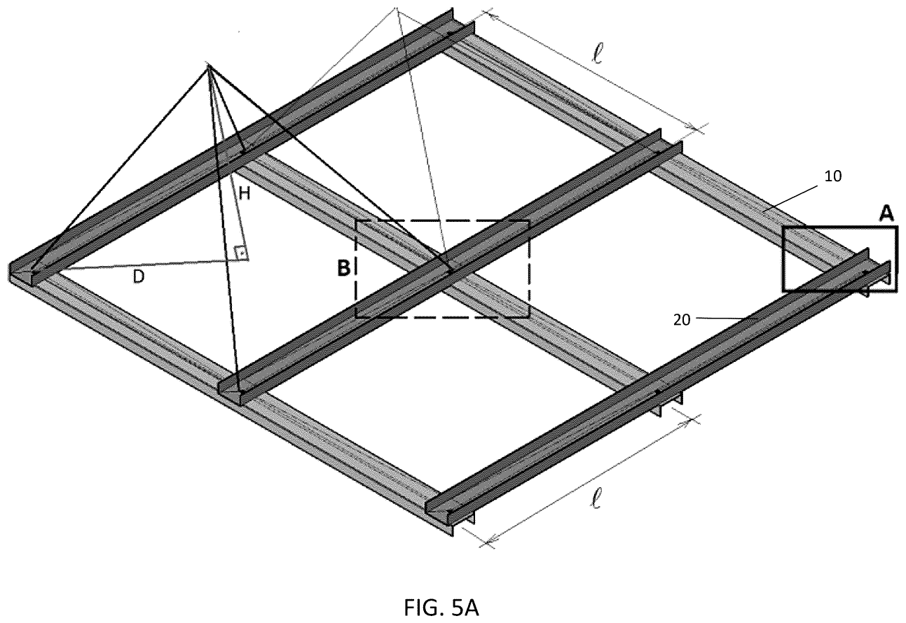

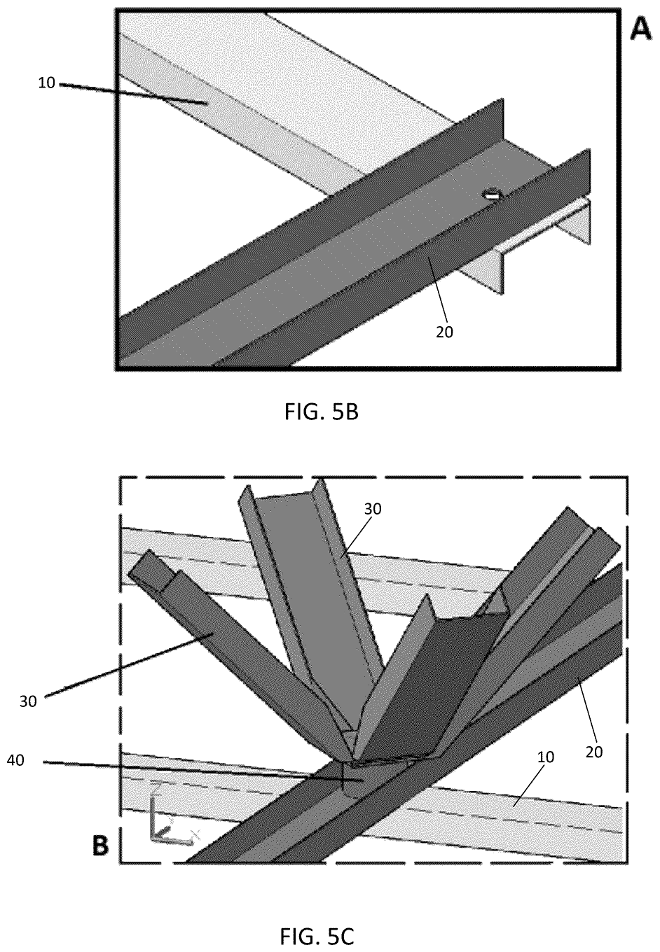

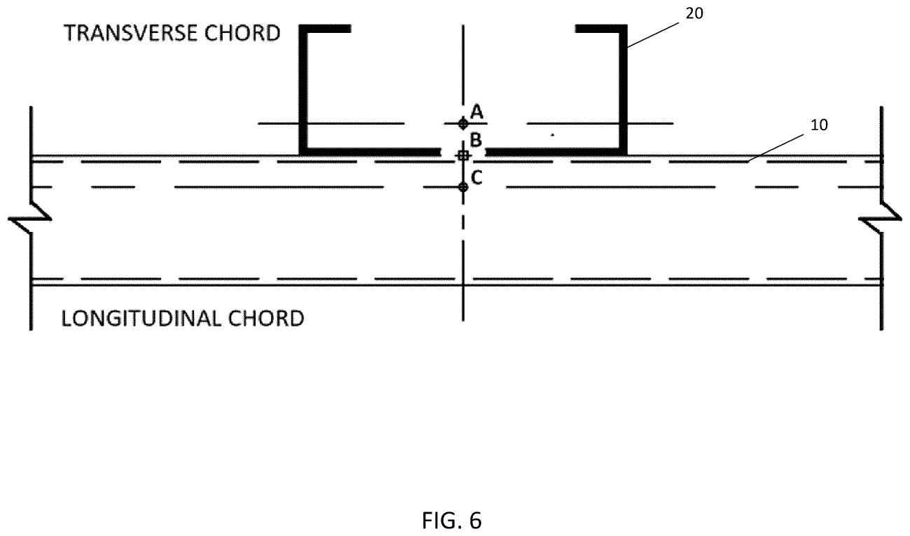

Next, FIG. 5A shows one possible assembly methodology, among others, of exemplary cold-formed bars in multidimensional trusses. Here, the chords 10, 20 (FIGS. 5A-5B) and diagonals 30 (FIG. 5C) are connected by a single bolt with a spacer or web 40 (FIG. 5C) between them. It is possible to observe that bottom chords are placed in contact of the spacer's or web's surfaces, where the web is a wood piece connecting the top and bottom chords of the truss structure. Considering this chord arrangement, the points A and C in FIG. 6 are, respectively, the centroid of transverse and longitudinal chord. The resultant of the bottom chord axis is the interface between bars 10, 20 (point B) due to this point being a middle distance between points A and C (FIGS. 5A-5C).

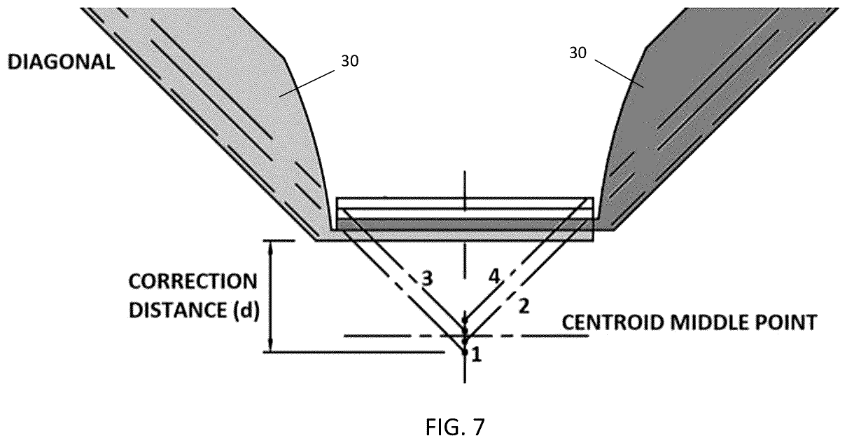

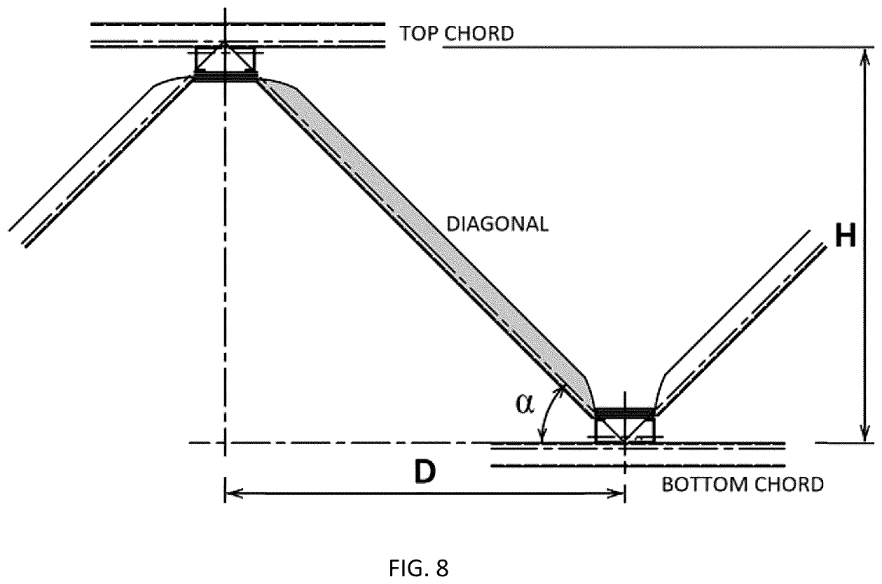

As illustrated in FIG. 7, a 3D diagonal assembly can be executed by putting one stamped end of diagonal bar 30 above the other 30, where the diagonal centroid's axes 1-4 intersect at a vertical axis that extends from a centroid middle point, where the centroid middle point is an ideal reference to obtain a distance correction (d), and the node center is defined as the intersection between the chord axis point and the centroid middle point of the diagonals.

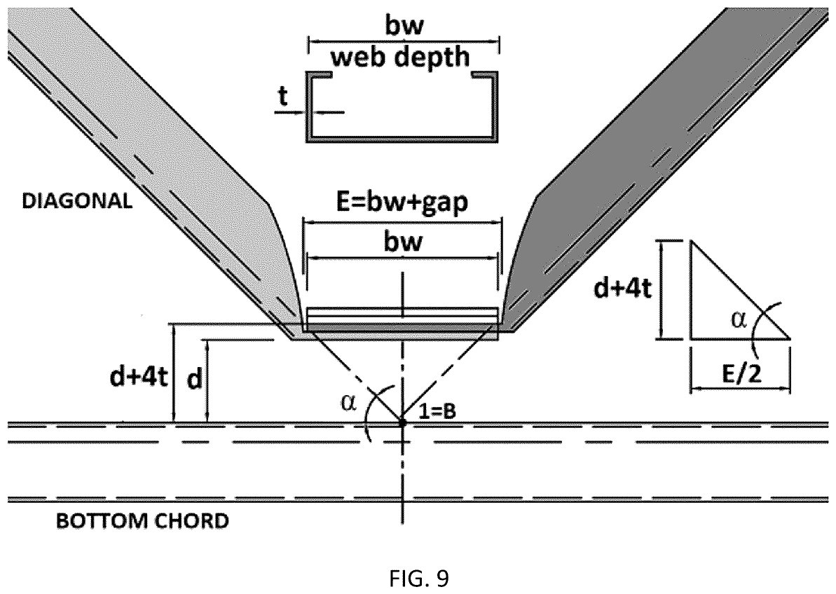

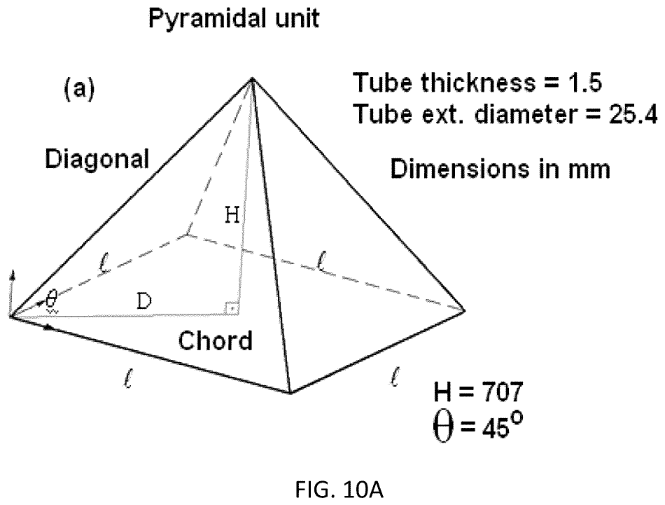

Referring to FIG. 8 and considering “H” as an internal height between the top and bottom chord, “D” as a planned distance between the nodes, and “α” as the angle of the diagonal bar 30 with respect to the top or bottom chord 10, 20, Equation 1 (below) defines the relationships between H, D, and α. Correspondingly, Equation 2 (below) expands Equation 1 by considering distance correction (d), the thickness (t) of the cold-formed diagonal, and “E” that equals to a web depth (bw) plus a gap, as illustrated in FIG. 9. Here, the distance “D” can be obtained by Equation 3 (below) and a planned projection of the node distance “ [symbol] ”. Lastly, Equation 4 (below) provides a formula of computing the distance correction, which is a result of combining Equations 1, 2 and 3.

$$tan ( α ) = \frac{H}{D} \qquad ( 1 )$$

$$tan ( α ) = \frac{( d + 4 t )}{( E / 2 )} \qquad ( 2 )$$

$$D = \frac{ℓ \sqrt{2}}{2} \qquad ( 3 )$$

$$d = \frac{H \cdot E}{ℓ \sqrt{2}} - 4 t \qquad ( 4 )$$

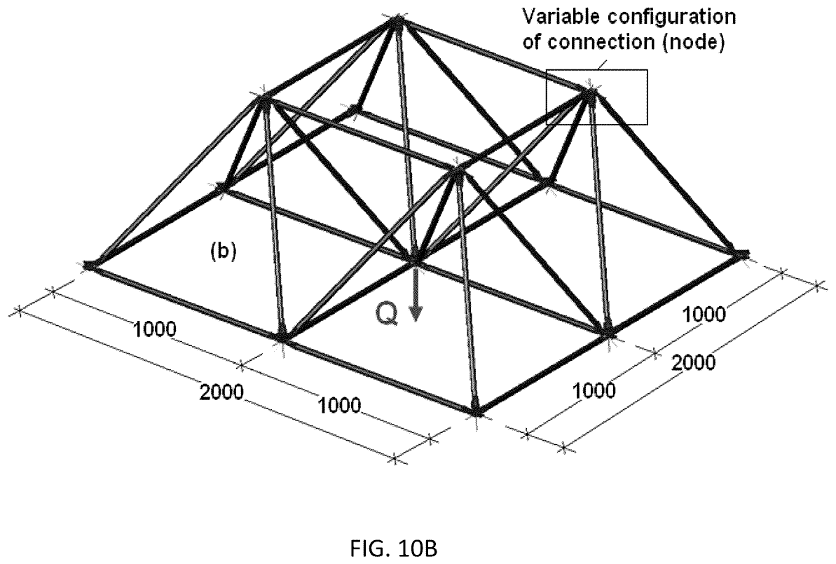

For evaluation purposes, validation of the exemplary cold-formed 3D trusses was compared against pipe 3D trusses using the truss design geometry in FIGS. 10A-10B. Here, the truss design is made of pyramidal units (FIG. 10A) connected at nodes corresponding to the pyramid vertices. Each pyramid has a square base with length I=1.00 m and height H=0.707 m. The diagonal inclination angles are, therefore, 45° with respect to the base plane of the pyramid. In this analysis, the chosen material was ASTM A36 (AISC, 1999) with the following engineering properties: yielding stress, 250 MPa; ultimate stress, 400 MPa; modulus of elasticity, 205000 MPa and Poisson's ratio 0.3. Restrictions for displacement and rotations were applied to nodes at the supports of the truss located at the corner-representing the support conditions which were replicated in the experimental tests. FIG. 10B shows the central node where the load “Q” was concentrated.

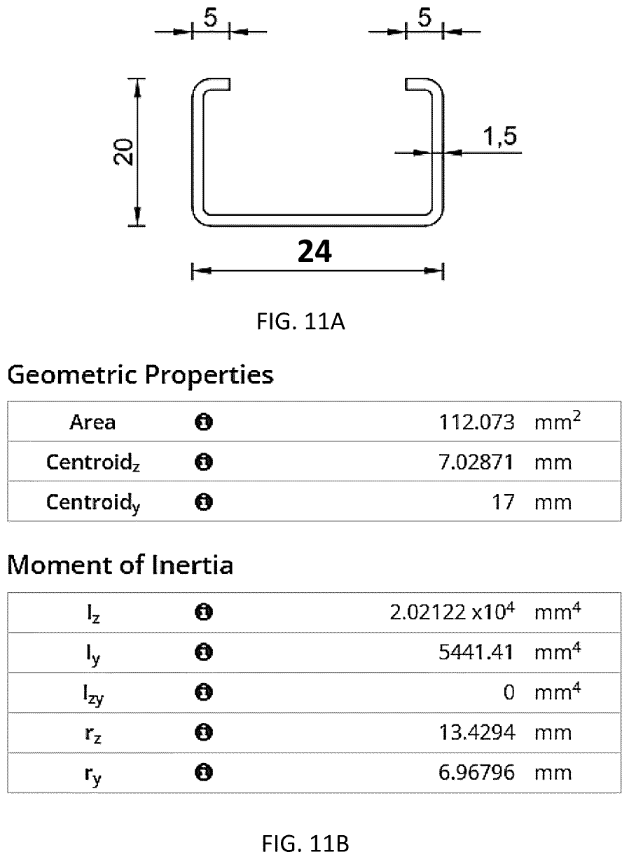

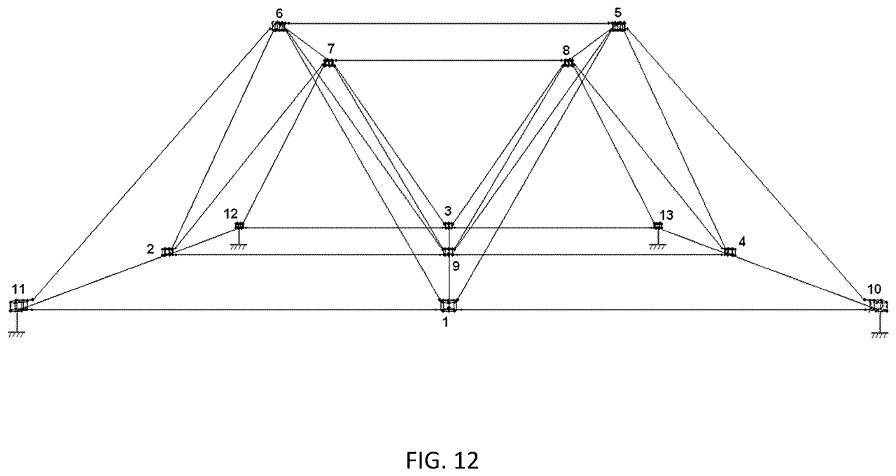

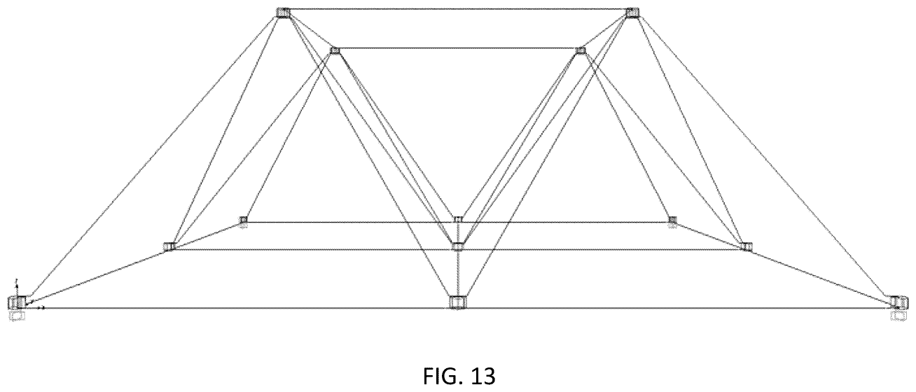

To compare the trusses with tubes and cold-formed, the design with steel cold-formed bars adopted the same cross-section area as the design which tubes (which is about 112.62 mm²), the same thickness 1.50 mm (0.059 in), and also the same eccentricity (60 mm). After applying Equation 5 (below), the spacer distance equaled to 24 mm, as illustrated in FIGS. 11A-11B.

$$d = \frac{H \cdot E}{ℓ \sqrt{2}} - 4 t \to d = \frac{707 \cdot 60}{1000 \sqrt{2}} - 4 x 1.5 \to d = 24 mm \qquad ( 5 )$$

With the different configurations, two models were represented: typical pipe connection with the spacer (FIG. 12), and the disclosed cold-formed application with the spacer (FIG. 13). Restraints were applied to nodes at the supports of the truss located at the corner. The 37 kN up-down load was applied at the middle node 9.

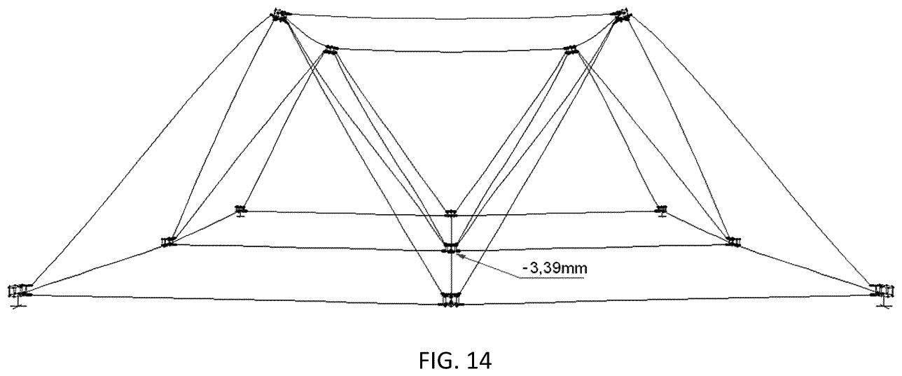

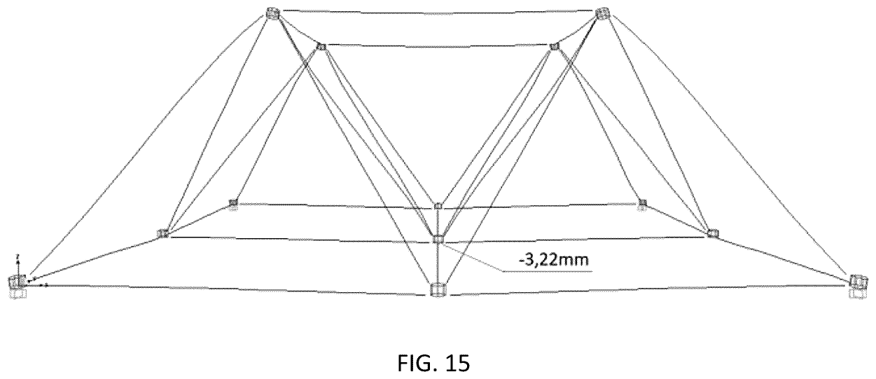

FIGS. 14 and 15 show, respectively, the vertical displacement results of a typical pipe node with spacer (Dmax=3.39 mm), and truss with cold-formed (Dmax=3.22 mm). The scales of deformation are theoretical and the same for all models, and about 15 times that of actual measurements to emphasize the displacements. The disclosed design with cold-formed and the typical pipe node design with spacer were observed to have almost the same displacements.

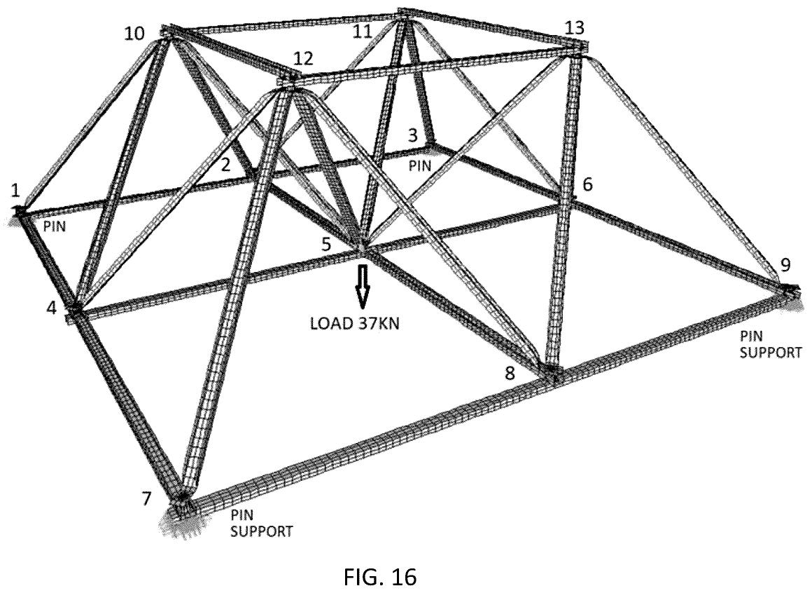

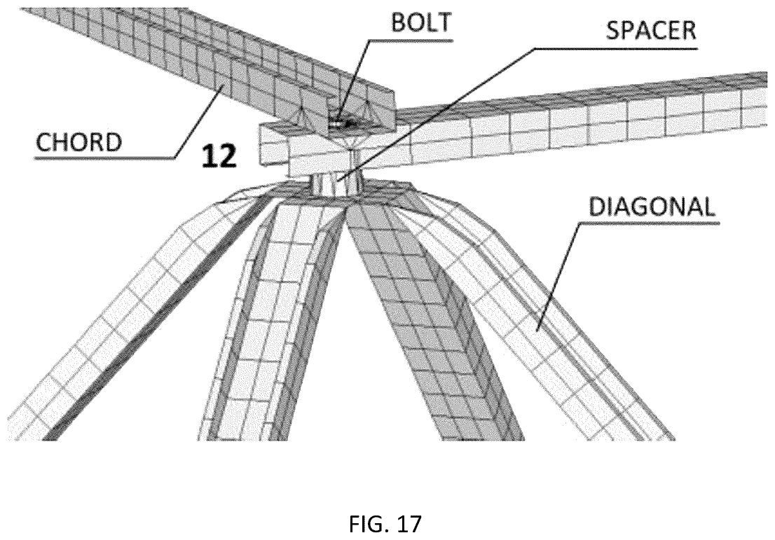

Next, a deep numerical study was made for the cold-formed structure using the same geometry, restraints, materials and load of the last study. However, a shell element was used instead of frame element in finite element (FE) modeling of the cold-formed bars. Accordingly, FIG. 16 shows the FE model, and FIG. 17 depicts details of node 12 in FIG. 16.

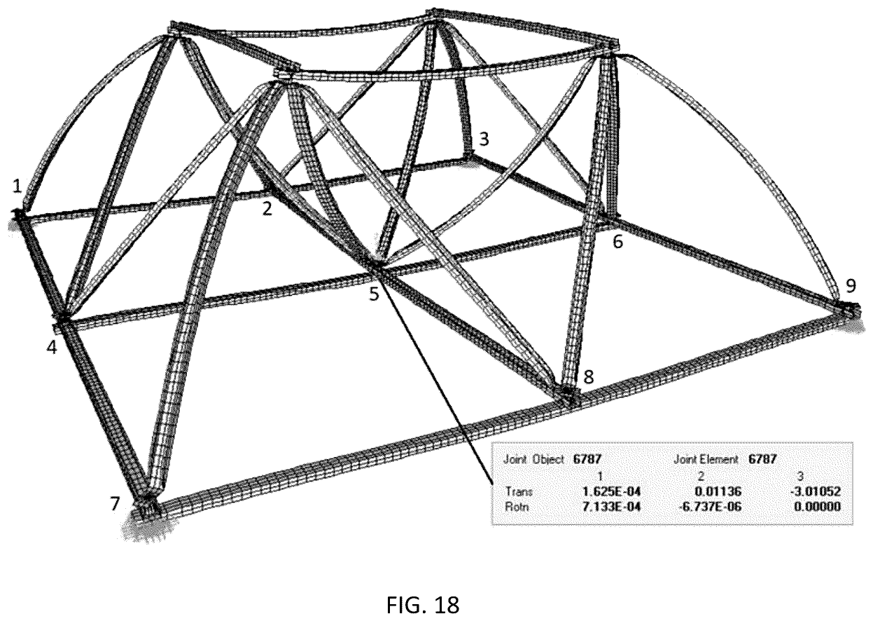

Correspondingly, FIG. 18 shows the vertical displacement results of the truss with cold-formed bars (Dmax=3.01 mm, vertical translation axis 3). The scale of deformation is about 15 times of actual measurements to emphasize the displacements. The displacement result of the shell element model, 3.01 mm, is almost the same as frame element model, 3.22 mm (as shown in FIG. 15). The limit yielding stress is about 250 MPa with the linear elastic behavior of the material ASTM A36 (AISC, 1999) only being considered. Tests were performed to show the minimum stress or compression in the shell elements of the top chords, corners, and internal diagonals, which resulted in 172 MPa of compression and traction being approximately obtained in the middle of the cold-formed bars. The concentration of stress was observed in the end of the bars. Von Mises Stress testing in the connection resulted in about 250 PMa of stress, where the Von Mises Stress test provides a measure of the shear, or distortional, stress in the material. This type of stress tends to cause yielding in metals. As such, the FE model with shell elements shows compatible behavior in comparison with frame element and these results show significant practical application of the trusses with cold-formed bars. Additional testing was executed at Structural Testing Laboratory at the University of North Texas. Three tests were carried out on the same design, and in each subsequent test, the flaws were corrected and structural strength was implemented.

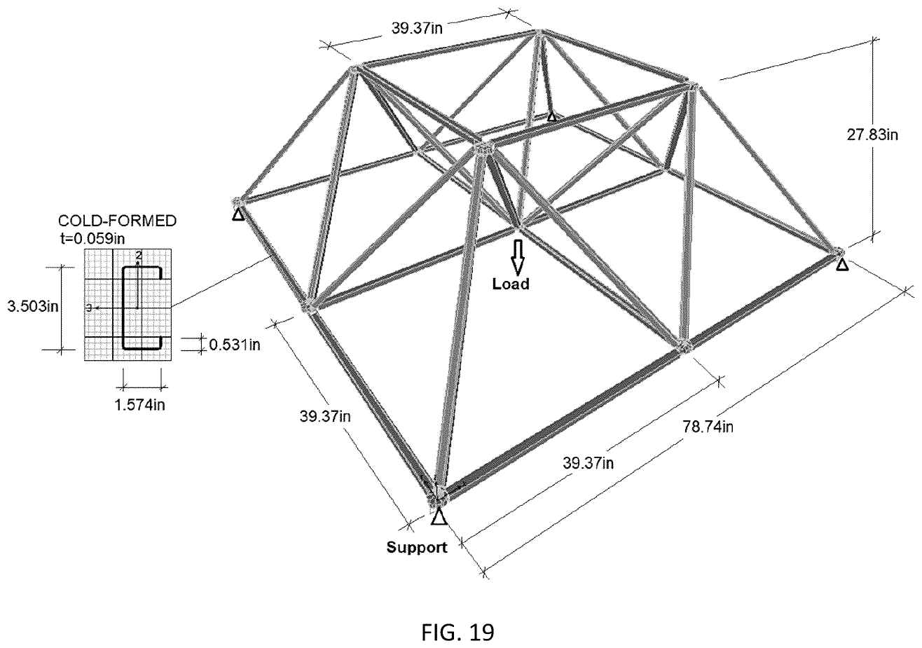

FIG. 19 shows the geometry adopted for a truss design in accordance with various embodiments of the present disclosure. This truss design was made of pyramidal units connected at nodes and each pyramid has a square base with length L=39.37 in (1,000 mm) and height H=27.83 in (707 mm). The diagonal inclination angles are, therefore, 45° with respect to the base plane of the pyramid. The cold-formed dimensions are 3.503 in×1.574 in×0.531 in with thickness of 0.059 in. Material properties were tensile strength of steel at Fy-50 ksi; modulus of elasticity at 29,000 ksi, and Poisson's ratio of 0.3. Restrictions for displacement and rotations were applied to nodes at the supports of the truss located at the corner-representing the support conditions which were replicated in the experimental tests. The load was applied at the central node.

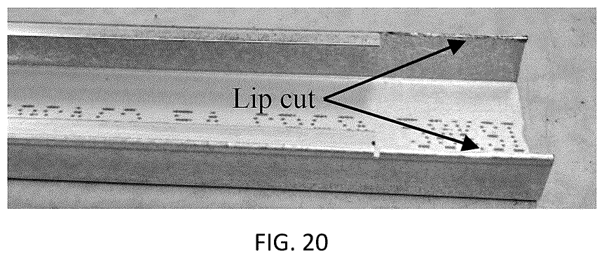

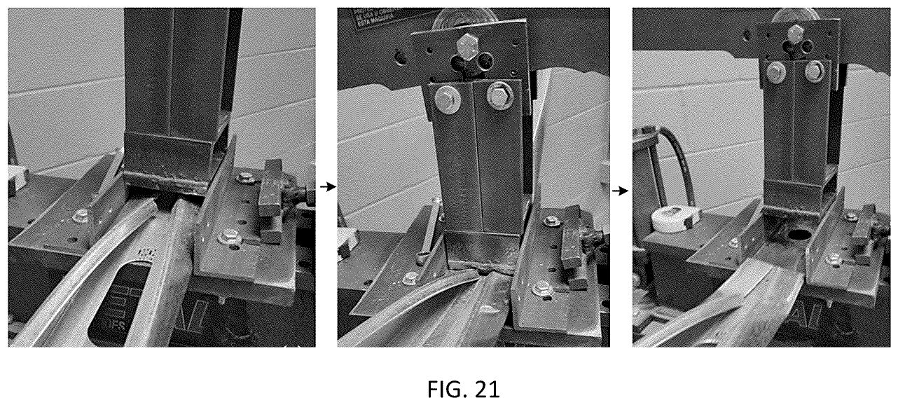

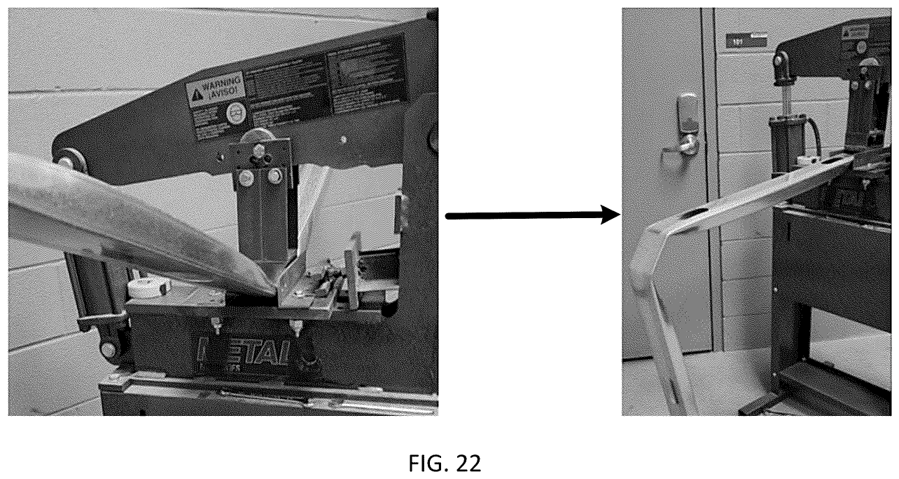

In various embodiments, the manufacture of top and bottom chords are achieved by cutting the cold-formed bars and making a hole for a bolt. The diagonals may then be manufactured by cutting a lip in the cold-formed bars, as shown in FIG. 20, and performing a bending process in a hydraulic machine, as shown in FIG. 21. After the bending is completed to form the stamped portion of the diagonal and the end is raised at a desired angle, as shown in FIG. 22, a hole may be added for receiving a bolt (e.g., having a diameters of ⅜ in (9.46 mm).

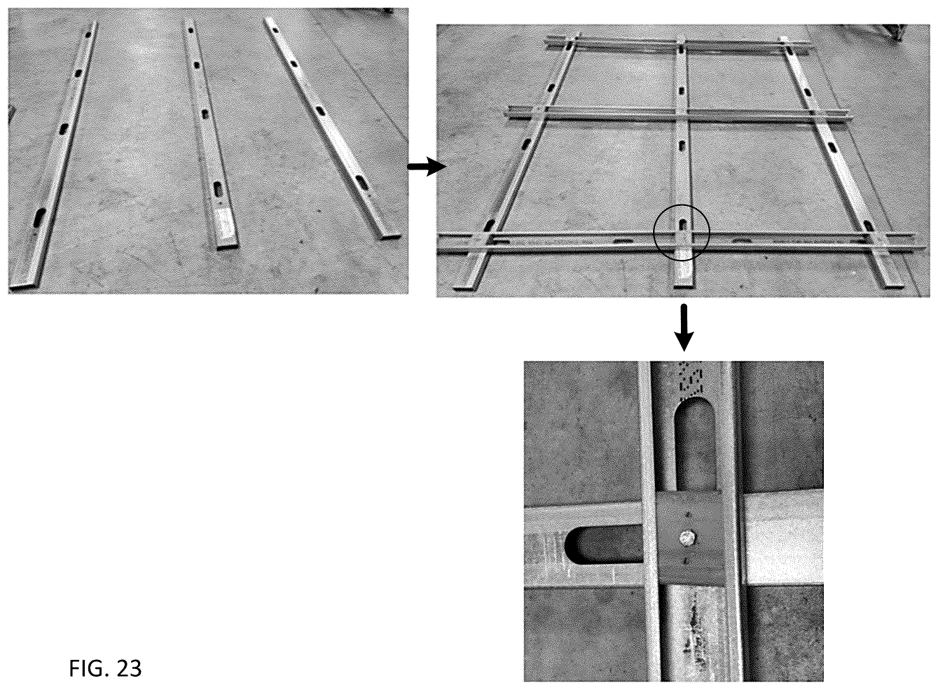

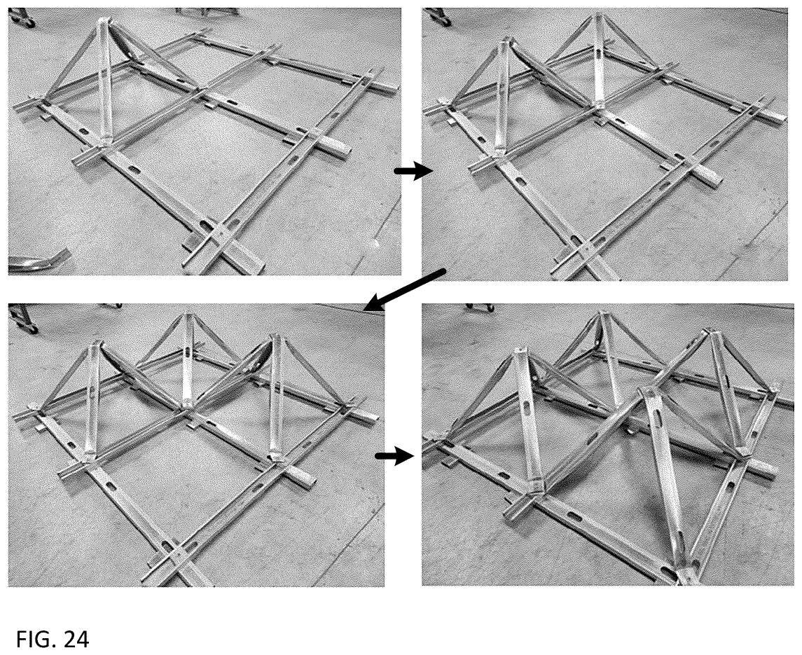

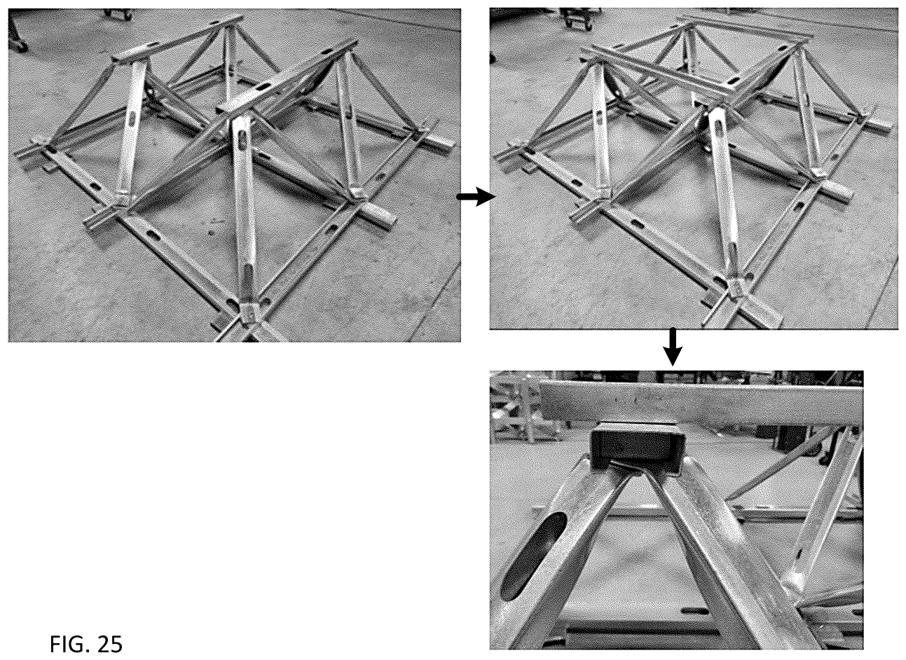

In various embodiments, the assembly of a 3D cold-formed space structure begins with (1) the arrangement of the bottom chords, (2) arrangement of transversal chords in a perpendicular direction over the bottom chords (3) with webs or wood spacers used to connect the chord pieces with bolts, as shown in FIG. 23. The diagonals pieces may be placed in pairs forming pyramids, using loose bolts, as shown in the sequential photographic images of FIG. 24. The top chords bars may be installed over the diagonals and fixed by the webs and with the spacers downwards, as shown in the photographic sequences of FIG. 25. Once all bars were in place, the bolts can be tightened.

In general, the shape of component members and how they are connected determines the paths that loads take through a truss. Concentric, or symmetrical, trusses allow for the load path to be transmitted through the center of gravity of the member. Eccentric, or asymmetrical, allows for the load path to be transmitted away from the center of gravity. The efficiency of a CFS truss is greatly dependent on the shapes of component members and how they are connected. For example, some asymmetrical trusses can result in eccentric load path, less lateral stability, and a less efficient truss.

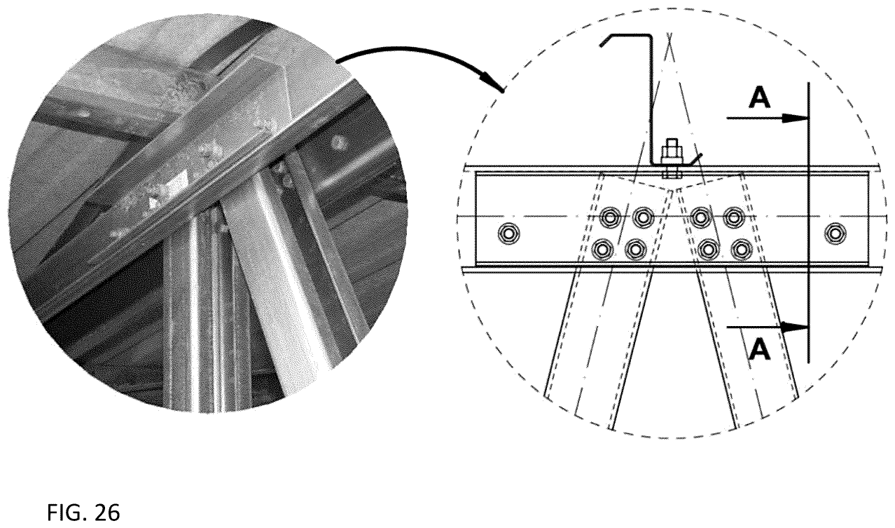

As shown in FIG. 26, when the diagonal bars and chords are placed with concentric axes, this results in the creation of positive eccentricities in the truss joints, and hence bending moments and shear forces in the chords of lattice girders. Such additional internal forces should be taken into account when truss members are designed.

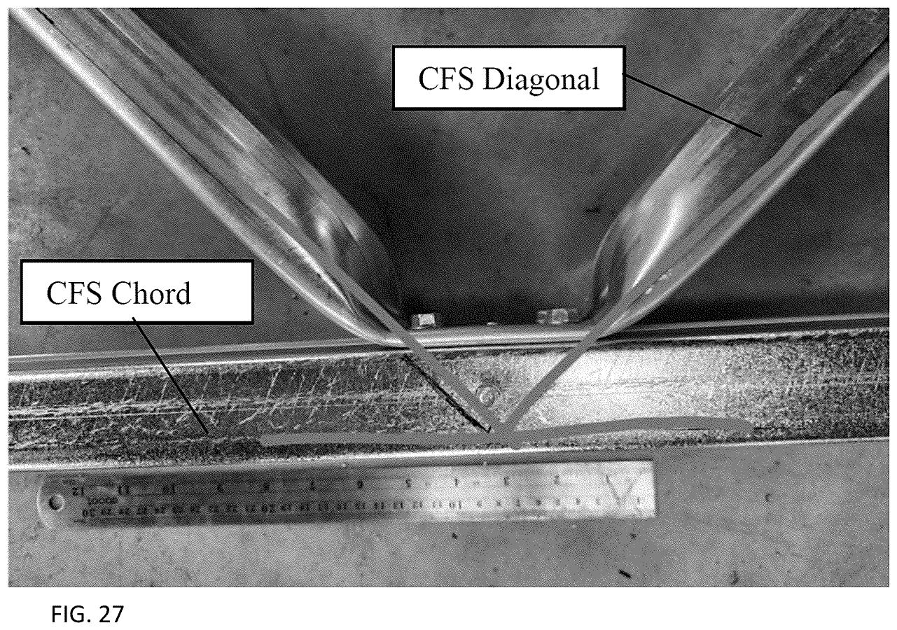

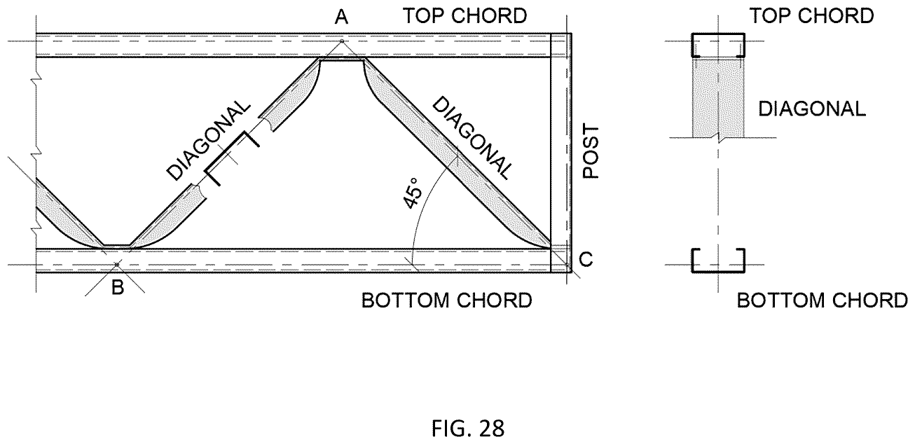

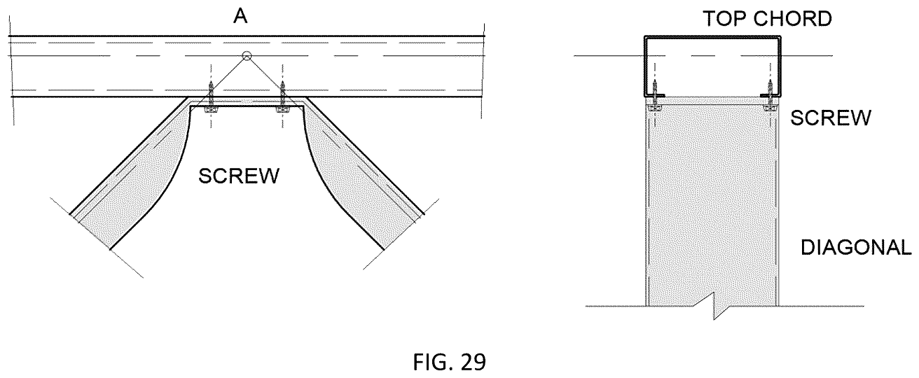

Based on the diagonal stamped conception of the present disclosure, a geometric detailing was developed to check if was there any eccentricity in this type of novel node connection. Accordingly, in FIGS. 27-28, the diagonal and chords bars are drawn with their respective axes of inertia. It is possible to observe that the axes are concentric (same point of intersection), between diagonal and top chord (point A), between diagonal and bottom chord (point B) and diagonal and post (point C). FIG. 29 shows the fixation detail between bars with screws.

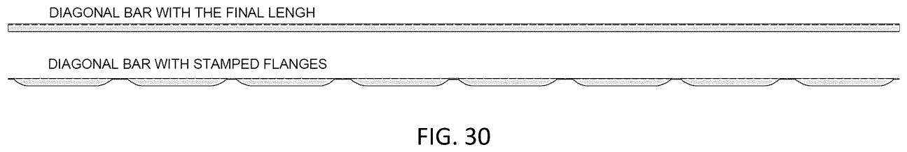

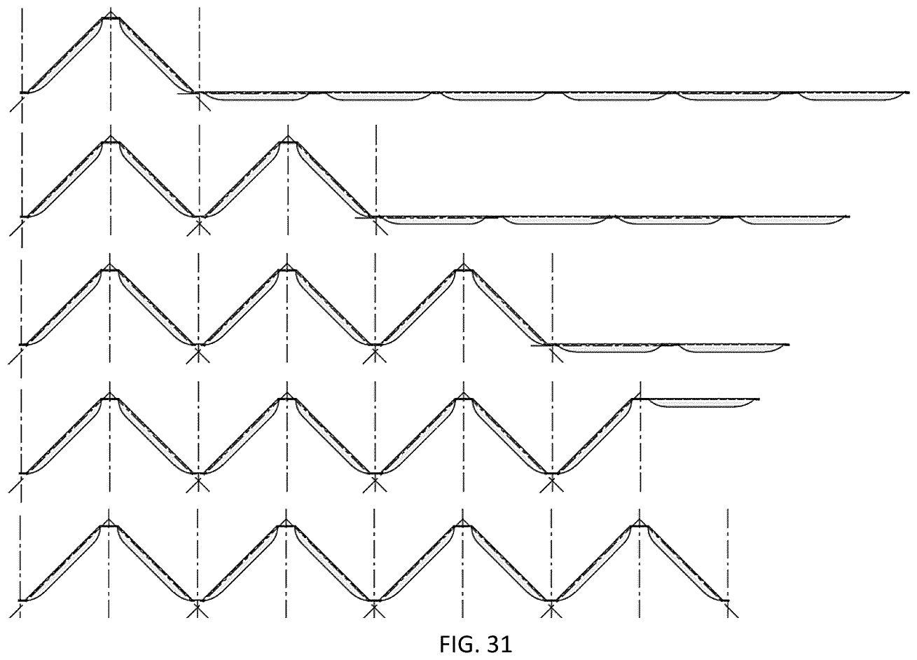

As mentioned, one advantage, among others, of the present disclosure is the option of automating the manufacturing process in which the diagonals can be stamped continuously creating a unified element. In accordance with various embodiments, an exemplary continuous manufacturing sequence involves stamping the profile flanges (FIG. 30), bending the bars to the length and specific angle generating the diagonals (FIG. 31), and then easily assembling a 2D space structure or truss (FIG. 32). For such 2D space structures, this process optimizes the assembly of the truss as there are only three interconnected parts to be placed: a single diagonal, chords, and posts members.

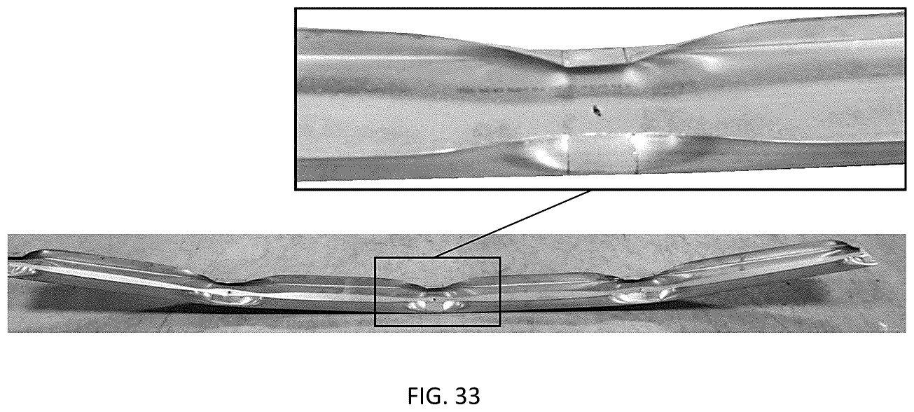

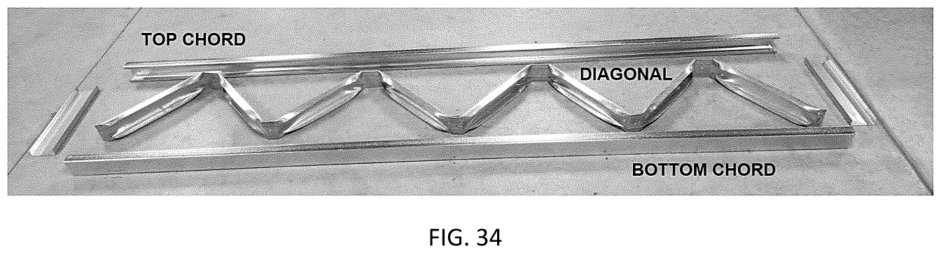

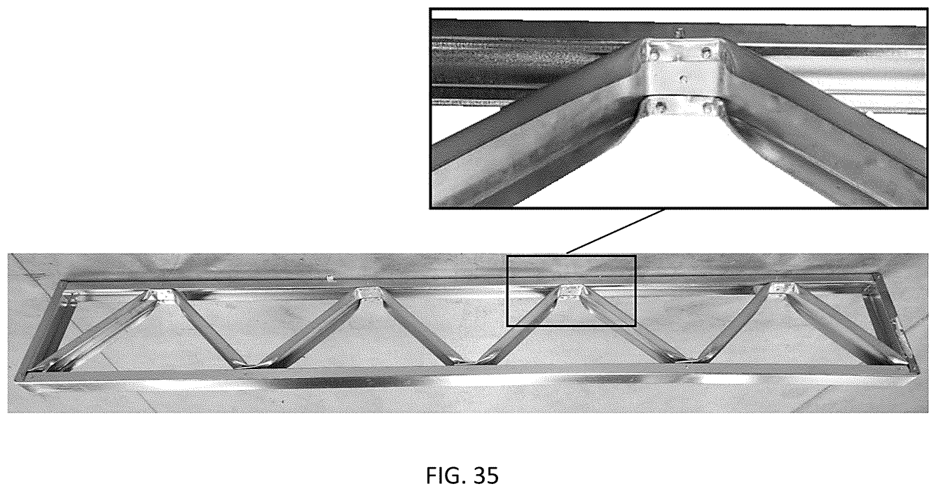

FIGS. 33-35 are sequential images depicting manufacture of a stamped CFS diagonal member, in accordance with various embodiments of the present disclosure. In particular, FIG. 33 shows stamped flanges of an exemplary CFS diagonal member. In this exemplary diagonal member, the CFS bar will be bent to form alternating peaks between the two stamped ends, where each peak portion comprises a stamped flange that can be connected to top or bottom chords, as shown in FIG. 34. In particular, FIG. 34 shows the disassembled parts of a 2D space truss with cold-formed bars. It is noted that the top and bottom chords do not require stamp ends and may just feature a hole for a screw connection with the stamped portions of the diagonal member. Finally, FIG. 35 shows an assembled 2D space structure truss of cold-formed members with a stamped diagonal, in accordance with various embodiments of the present disclosure.

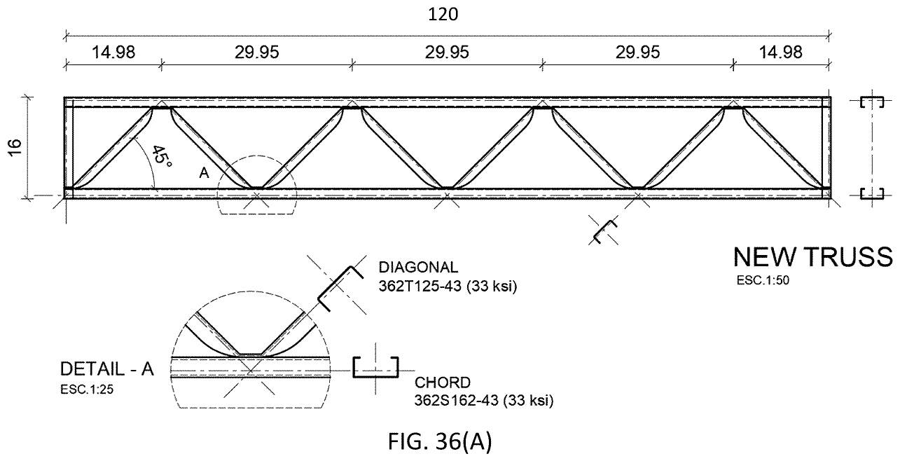

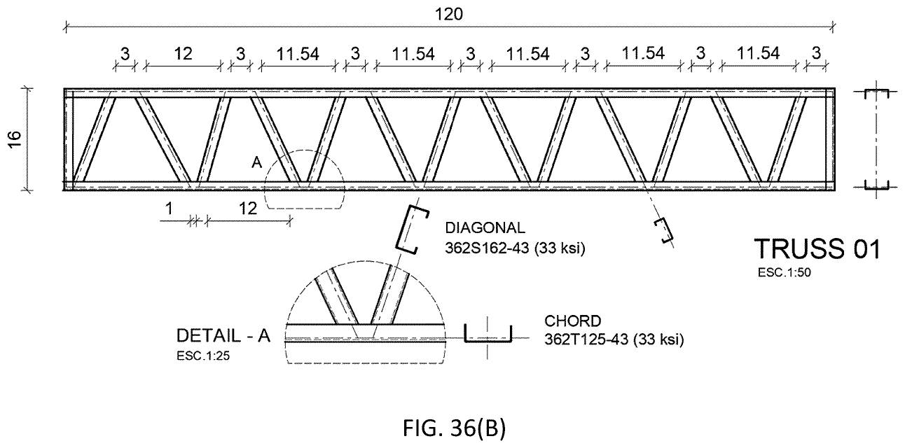

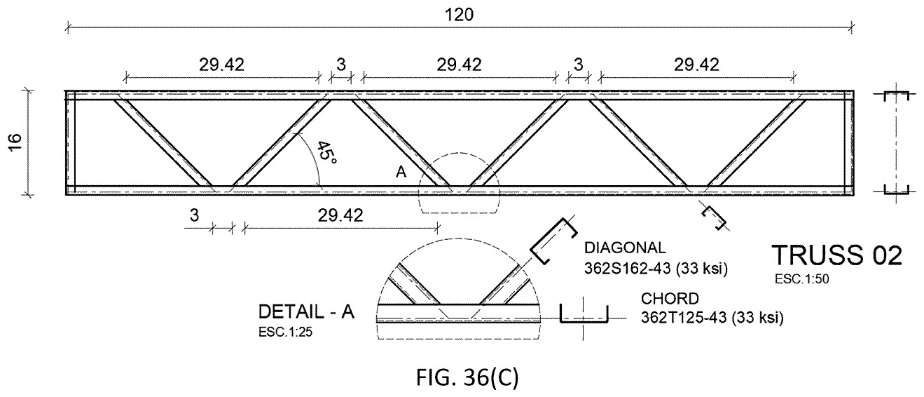

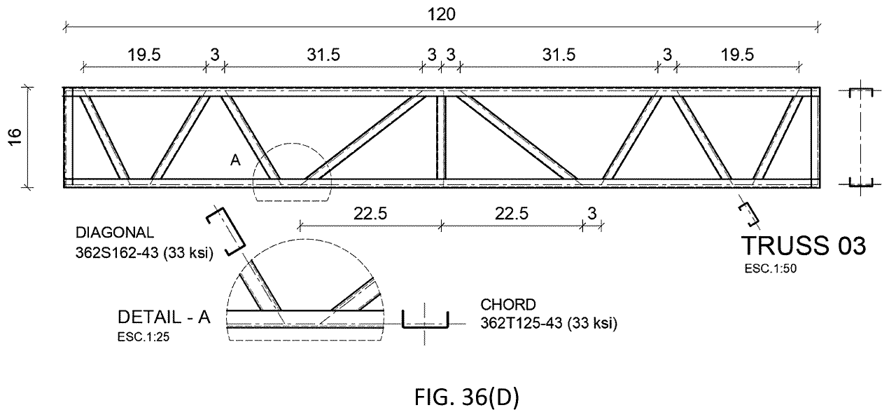

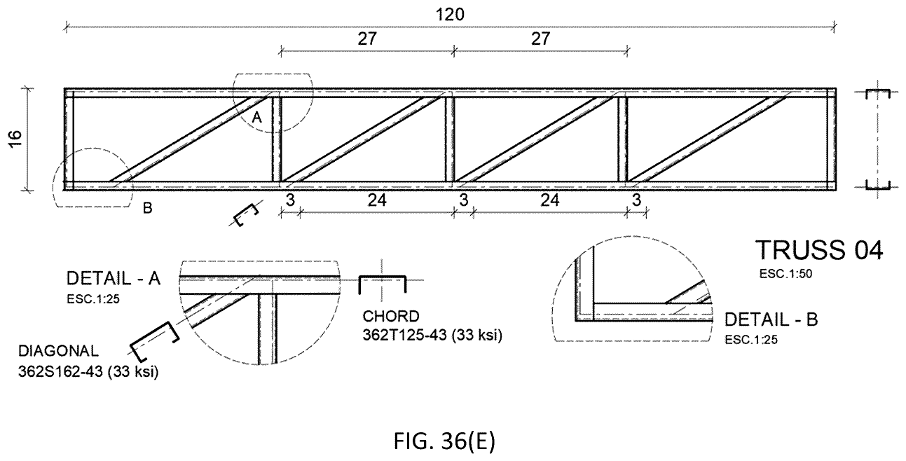

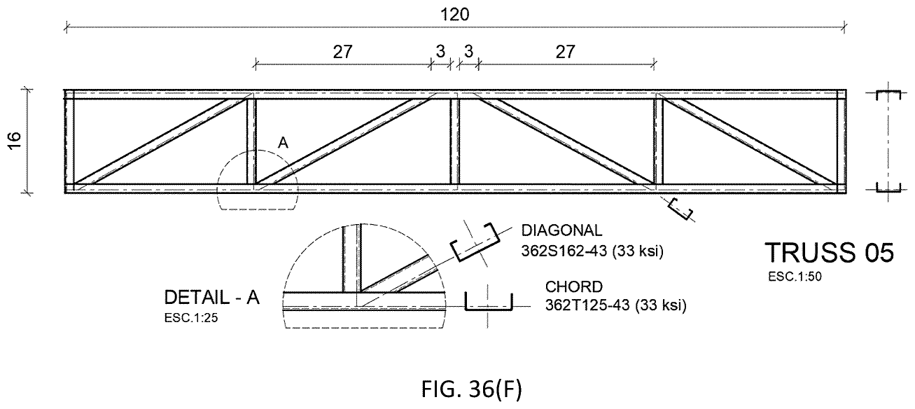

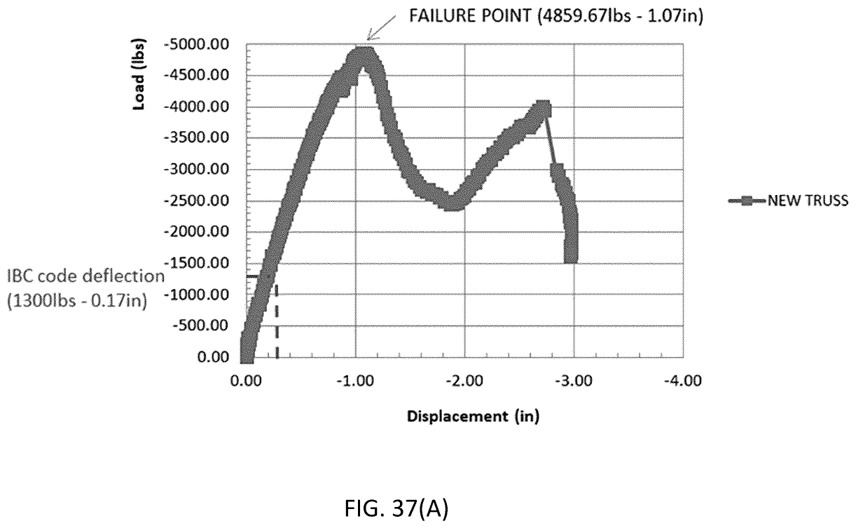

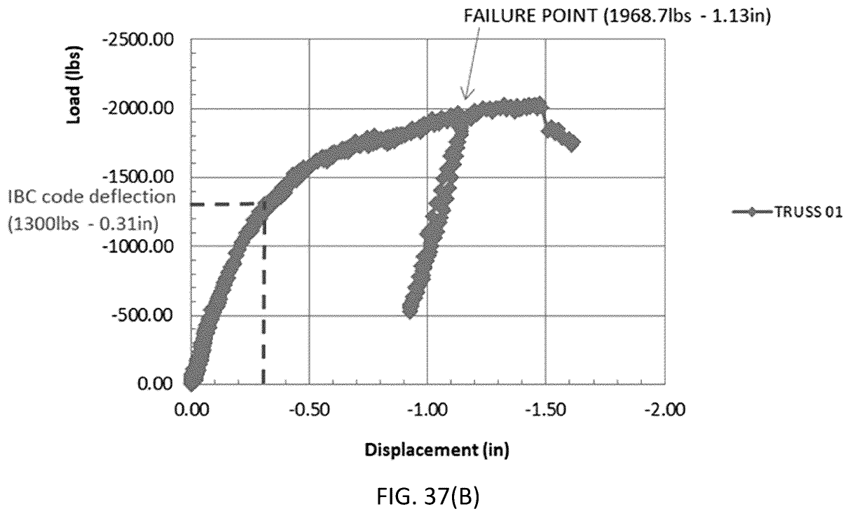

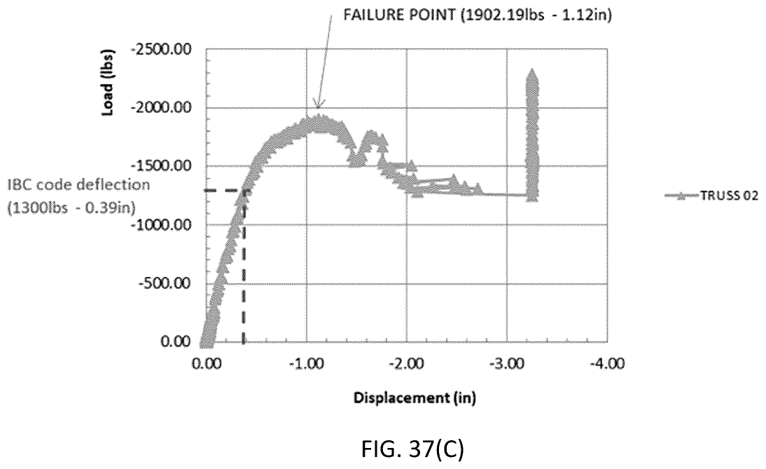

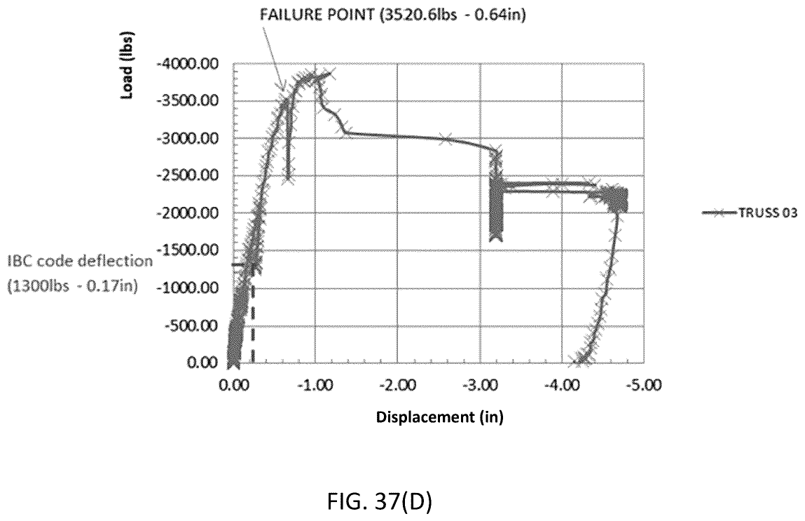

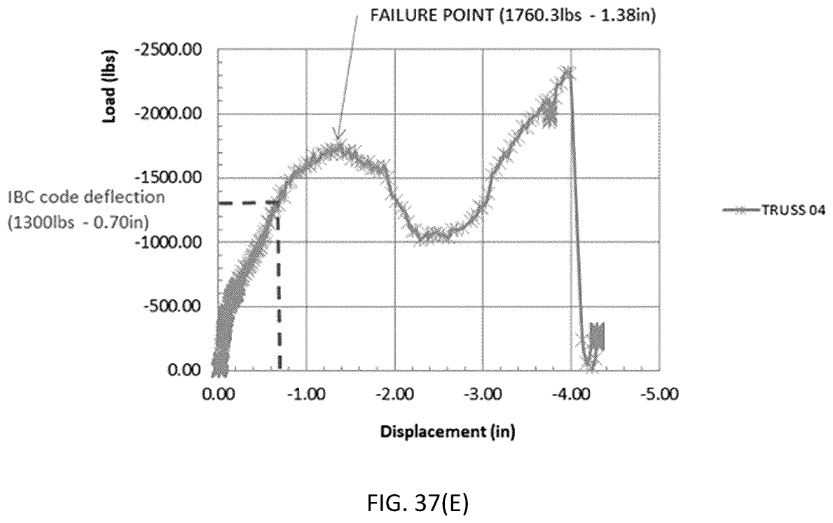

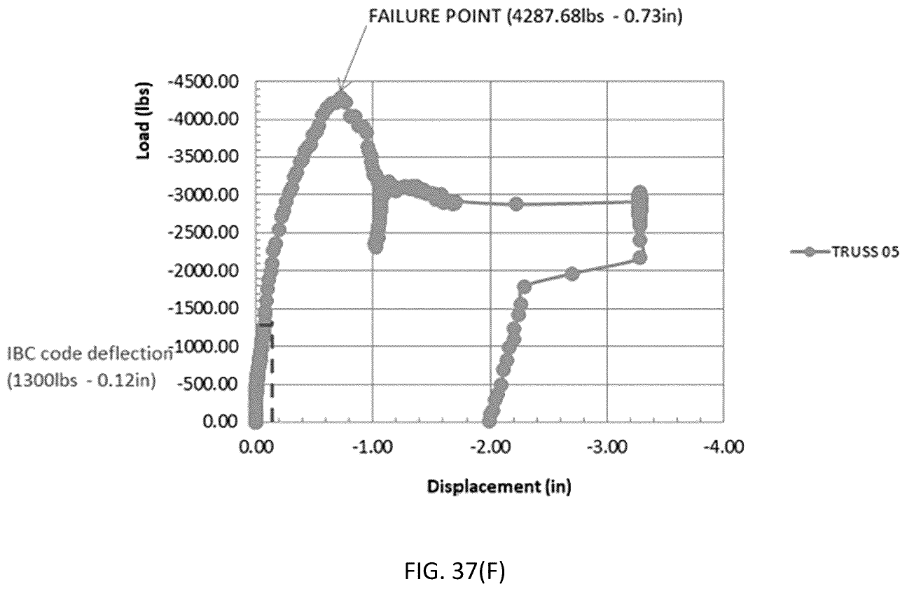

In turn, FIG. 36(A) shows the general geometry adopted for the assembled 2D space structure truss of FIG. 35. The design of FIG. 36(A) was tested against 5 typical geometry 2D truss designs (FIG. 36(B)-FIG. 36(F)) using the same external dimensions and bars characteristics, but with different diagonals positions. The track member 362T125-43 (member 148 weight per foot of length is 0.94 lb/ft) and the web members were 362S162-4 (Member weight per 149 foot of length is 1.16 lb/ft) both being 33 ksi. In FIGS. 26(A)-26(F), it is possible to observe all dimensions, characteristics of used profiles and mainly the degree of connection eccentricities due to the placement of the bar axes. In Table 1 (below) are the specifications of all material used in the various trusses and total weight. The equipment used in the tests include a hydraulic actuator, where experiment pump control and data acquisition was performed using several modern computer-driven systems. A linear variable differential transformer (LVDT) was used to monitor a vertical displacement in a middle span of truss, and a load cell was placed in the corner of the truss being tested.

TABLE 1

| | Top and bottom chord | | Diagonal | | Total |
|---|---|---|---|---|---|
| | length | weight | length | weight | Self- |
| TRUSS | (in) | member (lbs) | (in) | member (lbs) | weight (lbs) |
| 1 | 272.00 | 21.31 | 210.00 | 20.30 | 41.61 |
| 2 | 272.00 | 21.31 | 127.08 | 12.28 | 33.59 |
| 3 | 272.00 | 21.31 | 167.00 | 16.14 | 37.45 |
| 4 | 272.00 | 21.31 | 160.80 | 15.54 | 36.85 |
| 5 | 272.00 | 21.31 | 169.00 | 16.34 | 37.64 |
| New Truss | 240.00 | 23.20 | 193.16 | 15.13 | 38.33 |

After experimental tests were conducted, it was found that an exemplary 2D CFS space structure offers higher strength, faster construction, and less materials than typical or conventional truss designs. To demonstrate, the test structures collapsed under the following conditions: Truss 01 (collapse load 1,968.7 lbs and displacement 1.13 in), Truss 02 (load 1,902.19 lbs and disp. 1.12 in), Truss 03 (load 3,520.6 lbs and disp. 0.64 in), Truss 04 (load 1,760.3 lbs and disp. 1.38 in), Truss 05 (load 202 4,287.68 lbs and displ.0.73 in), and New Truss (load 4,859.67 lbs and disp.1.07 in). FIGS. 27(A)-27(F) to shows graph of the “Load vs. Displacement” for the structural tests, where FIG. 27(A) is corresponds to the New Truss design in accordance with the present disclosure and FIGS. 27(B)-27(F) corresponds to the typical truss designs Truss 01-Truss 05.

In these graphs, it is possible to observe the elastic and plastic behaviors, and also the load where the structure collapsed (failure point). One important information to observe is the elastic displacement limit of the standard. This displacement is limited, according to the international building code (IBC code), to l/240 of the total span of the truss (120 in/240=0.50 in). Thus, hypothetically, considering the following practical loads: 40 psf (live load) and 20 psf (dead load), a total load of 60 psf is adopted, if t we assume the truss is spaced at 26, then an influence area of 21.66 ft2 (120 in×26 in) results. As such, the limit displacement of the IBC code (0.50 in) must be checked by elastic load of 1,300 lbs in the experimental test. By this load, the following displacements were observed: 0.31 in (Truss 01), 0.39 in (Truss 02), 0.17 in (Truss 03), 0.70 in (Truss 04), 0.12 in (Truss05), and 0.17 in (New Truss). Considering the limit displacement of the IBC code, it was observed that only “Truss 04” failed in this criterion.

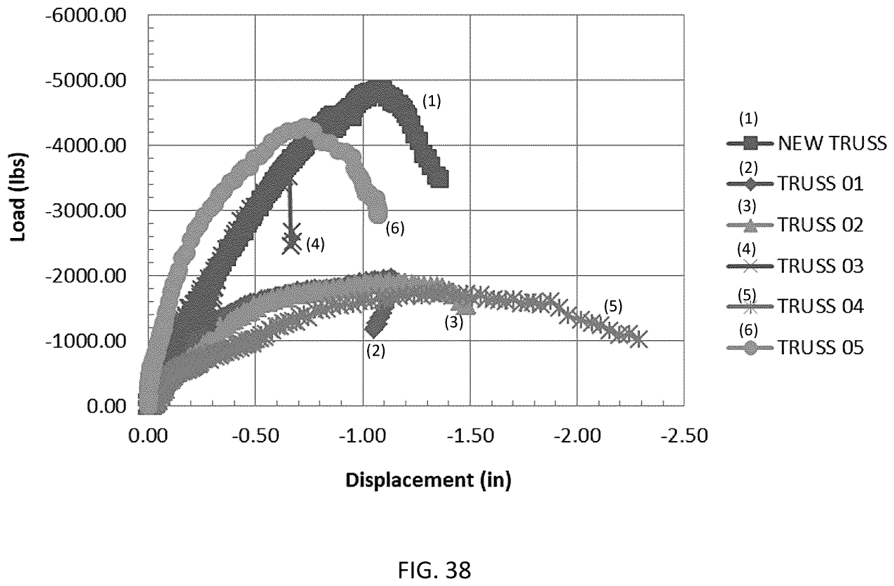

FIG. 38 shows all six tests plotted in the same graph of load versus displacement which shows that the New Truss design presented the greater load capacity. The Table 2 (below) shows a comparison of the load capacity and self-weight of the test structures. Given that the ratio between experimental load and self-weight is an important aspect to observe, the New Truss design presented the best ratio (126.78) and became a reference model (100%) as compared to the others structures.

TABLE 2

| | Self-weight | Experimental | Load/Weight | Relation to |
|---|---|---|---|---|
| TRUSS | (lbs) | Load (lbs) | Ratio | Reference model |
| 1 | 41.61 | 1968.70 | 47.32 | 37.32% |
| 2 | 33.59 | 1902.19 | 56.63 | 44.67% |
| 3 | 37.45 | 3520.60 | 94.01 | 74.15% |
| 4 | 36.85 | 1760.30 | 47.77 | 37.68% |
| 5 | 37.64 | 4287.68 | 113.90 | 89.84% |
| New Truss | 38.33 | 4859.67 | 126.78 | 100.00% |

It should be emphasized that the disclosed embodiments are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y.’”

We claim:

1. A space structure assembly comprising:
a bottom chord formed member of cold-formed steel;
a top chord formed member of cold-formed steel; and
at least one diagonal truss member formed of cold-formed steel and having at least two stamped ends,
wherein one end of the stamped ends of the at least one diagonal truss member is connected to the bottom chord and a portion of the at least one diagonal truss member is connected to the top chord.

2. The space structure assembly of claim 1, wherein the portion of the at least one diagonal truss member connected to the top chord comprises another end of the stamped ends of the at least one diagonal truss member.

3. The space structure assembly of claim 1, wherein axes of inertia of the at least one diagonal truss member is concentric with an axis of inertia of the top chord.

4. The space structure assembly of claim 1, wherein the at least one diagonal truss member comprises a first diagonal truss member and a second diagonal truss member, wherein one stamped end of the first diagonal truss member is connected to the top chord and one stamped end of the second diagonal truss member.

5. The space structure assembly of claim 4, wherein the at least one diagonal truss member comprises four diagonal members, each having a stamped end, wherein a single bolt connects the stamped ends of the four diagonal members to one another and the top chord via a single bolt to form a pyramidal unit having a square base.

6. The space structure assembly of claim 5, wherein axes of inertia of the diagonal truss members are concentric with an axis of inertia of the top chord.

7. The space structure assembly of claim 5, wherein the first diagonal truss member and the second diagonal truss member do not have a stamped flange between their two ends.

8. The space structure assembly of claim 1, wherein the connections are made using bolts and/or spacers.

9. The space structure assembly of claim 1, wherein the at least one diagonal truss member comprises a diagonal truss member that is connected to the top chord and the bottom chord, wherein the diagonal truss member bends and has a plurality of stamped flanges occurring at peaks between two ends of the diagonal truss member, wherein alternating ones of the stamped flanges are connected to the top chord and remaining ones of the stamped flanges are connected to the bottom chord.

10. A method comprising:
arranging a plurality of bottom truss chords in parallel with one another, wherein the plurality of bottom truss chords comprise cold-formed steel members;
connecting a plurality of diagonal truss members in pairs to individual ones of the bottom truss chords using a single bolt, wherein the plurality of diagonal truss members comprise cold-formed steel members having two stamped ends; and
forming a pyramidal structural unit by connecting four stamped ends of four of the plurality of diagonal truss members with a top chords using a single bolt.

11. The method of claim 10, further comprising:
arranging a plurality of transversal truss chords in a perpendicular direction below the plurality of bottom truss chords, wherein the plurality of transversal truss chords comprise cold-formed steel members, wherein an individual one of the plurality of transversal truss chords is connected to the pyramidal structural unit using the single bolt.

12. The method of claim 10, further comprising manufacturing a diagonal truss member by cutting a lip in a cold-formed bar and bending the cold-formed bar to form stamped portions of the diagonal truss member and raising each end at a desired angle.

13. The method of claim 10, wherein an axis of inertia of a diagonal truss member is concentric with an axis of inertia of a top truss chord.

14. A method comprising:
arranging a bottom truss chord in parallel with a top truss chord, wherein the bottom and top truss chords comprise cold-formed steel members; and
connecting a diagonal truss member to the bottom and top truss chords using a single bolt at a plurality of connection nodes, wherein the diagonal truss member comprises cold-formed steel members having two stamped ends and a plurality of stamped flanges between the two stamped ends, wherein the diagonal truss member bends and has the plurality of stamped flanges occurring at peaks between two ends of the diagonal truss member, wherein alternating ones of the stamped flanges are individually connected to the top truss chord using a single bolt and remaining ones of the stamped flanges are individually connected to the bottom truss chord using a single bolt.

15. The method of claim 14, wherein an axis of inertia of the diagonal truss member is concentric with an axis of inertia of the top truss chord.
